(19) United States
(12) Patent Application Publication
(10) Pub. No.: US 2008/0229050 A1
(43) Pub. Date: Sep. 18, 2008

(54) DYNAMIC PAGE ON DEMAND BUFFER SIZE FOR POWER SAVINGS

(75) Inventor: Magnus Tillgren, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/685,396

(22) Filed: Mar. 13, 2007

(51) Int. Cl. G06F 9/26

(52) U.S. Cl. 711/200

(57) ABSTRACT

A portable electronic device includes a processing device, a memory operatively coupled to said processing device, said memory comprising a plurality of blocks, wherein at least one block of the plurality of blocks may be powered independent of other blocks of the plurality of blocks, and a logic circuit operative to dynamically adjust a demand page buffer size within the memory and utilized by the processor, thereby permitting a corresponding adjustment of a number of powered memory blocks within the memory.

### TECHNICAL FIELD OF THE INVENTION

The present invention relates generally to electronic devices, such as electronic devices for engaging in voice communications. More particularly, the invention relates to a device and method for dynamically changing a demand page buffer size in electronic devices.

### DESCRIPTION OF THE RELATED ART

Mobile and/or wireless items of electronic devices are becoming increasingly popular. For example, mobile telephones are now in wide-spread use. In addition, the features associated with certain types of electronic devices have become increasingly diverse. To name a few examples, many electronic devices include cameras, text messaging capability, Internet browsing functionality, electronic mail capability, video playback capability, audio playback capability, image display capability, navigation capability, and hands-free headset interfaces.

Conventional mobile telephones often utilize memory for storing various data. A common form of memory utilized in many mobile telephones is SDRAM (synchronous dynamic random access memory). SDRAM is volatile memory (i.e., it needs power in order to retain data) and typically is offered in standard chip size packages, wherein each step up in size doubles the amount of memory available on the package. Further, SDRAM typically is partitioned in equally sized “blocks”. These blocks may be powered individually, such that only a portion of the memory on the chip package may be activated at any particular moment. Once activated, however, the entire block consumes power, even if the memory within the block is not utilized for data storage.

Another type of memory typically utilized in conventional mobile phones is non-volatile flash memory. As is well known, flash memory is electrically erasable, programmable, read-only memory (EEPROM) that can be erased and reprogrammed in blocks. Because they are non-volatile, flash memory does not need a constant power supply to retain data. NAND based flash memory is a new type of flash memory that utilizes NAND or serial access gate technology (as opposed to NOR or random access gate technology found in NOR flash memory). NAND flash memory is generally less costly to manufacture compared to traditional NOR based flash memory.

Volatile and non-volatile memory may be used for storing various data utilized by the processor of the mobile telephone. For example, a specific buffer may be used in volatile memory (e.g., in SDRAM) for demand paging functionality (also referred to as page on demand). Demand paging is an application of virtual memory, wherein the operating system copies a virtual page into physical memory only if an attempt is made to access the virtual page. For example, if the processor requires a portion of code stored in non-volatile memory (e.g., virtual memory), that portion may be copied into volatile memory (physical memory) as a page, and the processor then can access this page in physical memory.

Advantages of demand paging include: pages that are not accessed are not loaded, thereby saving memory for other programs; less loading latency during boot up; ability to run programs that consume more memory than is physically available; and there is no need for extra hardware support to implement demand paging.

In electronic devices such as mobile telephones, the buffer utilized for demand paging is a fixed size buffer. At a minimum there must be sufficient free memory in the mobile telephone to accommodate the fixed size demand page buffer, plus additional memory for other functions executed by the mobile telephone's processor. If the demand page buffer is relatively large, then a large number of memory blocks must be powered in order to accommodate the demand page buffer.

### SUMMARY

A drawback to having a large number of powered memory blocks in electronic equipment, such as a mobile telephone, is that the entire block consumes power, even if none or only some of the block is currently storing data. As the number of powered memory blocks increases, so to does the current drawn from the electronic device's battery. As will be appreciated, the more current drawn from the battery, the shorter the time that the battery can power the mobile telephone. While in certain circumstances it may be desirable to have a large number of powered memory blocks, from a power consumption standpoint, it is preferable to minimize the number of memory blocks, such as SDRAM blocks, that are powered in the electronic equipment.

The present invention provides a method and apparatus for dynamically setting a size of the demand page buffer utilized in electronic devices. By monitoring one or more parameters of the electronic device, the size of the demand page buffer can be dynamically changed, which enables the number of powered memory blocks to be minimized during certain operating conditions. For example, as the buffer size is reduced, power can be removed from unused memory blocks. As a result, current draw from the battery may be reduced, thereby increasing battery life. Should the conditions call for a larger size demand page buffer, the buffer size can be increased, and power can be applied to additional memory blocks.

According to one aspect of the invention, a portable electronic device includes: a processing device; a memory operatively coupled to said processing device, said memory comprising a plurality of blocks, wherein at least one block of the plurality of blocks may be powered independent of other blocks of the plurality of blocks; and a logic circuit operative to dynamically adjust a demand page buffer size within the memory and utilized by the processor, thereby permitting a corresponding adjustment of a number of powered memory blocks within the memory.

According to one aspect of the invention, the logic circuit is operative to dynamically adjust the demand page buffer size based on at least one operating characteristic of the electronic device.

According to one aspect of the invention, the logic circuit is operative to use at least one of an amount of free memory available to the processing device, a processing device load, a number of applications executed in parallel by the processing device, or a type of application executed by the processing device to adjust the demand page buffer size.

According to one aspect of the invention, the logic circuit is operative to increase the demand page buffer size as the processing device load increases, and decrease the demand page buffer size as the processing device load decreases.

According to one aspect of the invention, the logic circuit is operative to increase the demand page buffer size as the number of applications executed in parallel by the processing device increases, and decrease the demand page buffer size as the number of applications executed in parallel by the processing device decreases.

According to one aspect of the invention, the logic circuit is operative to select the demand page buffer size from a first buffer size and a second buffer size, wherein the second buffer size is smaller than the first buffer size.

According to one aspect of the invention, the logic circuit is operative to select the first buffer size when the amount of free memory available to the processing device is greater than a predetermined memory threshold value, a processing device load is greater than a predetermined load threshold value, a number of applications executed in parallel by the processing device is greater than an application number threshold value, or a type of application executed by the processing device creates a processor load greater than the load threshold value.

According to one aspect of the invention, the logic circuit is operative to select the second buffer size when the amount of free memory available to the processing device is less than a predetermined memory threshold value, a processing device load is less than a predetermined load threshold value, a number of applications executed in parallel by the processing device is less than an application number threshold value, or a type of application executed by the processing device creates a processor load less than the load threshold value.

According to one aspect of the invention, the logic circuit is operative to calculate the demand page buffer size so as to correspond to the at least one monitored operational characteristic.

According to one aspect of the invention, the logic circuit is operative to implement a hysteresis loop in the calculation of the demand page buffer size.

According to one aspect of the invention, the logic circuit is operative to power off memory blocks until a difference between an amount of memory defined by the remaining powered memory blocks and the quantity defined by the adjusted demand page buffer size and an amount of memory utilized for other processing operations is less than one memory block.

According to one aspect of the invention, the memory is static dynamic random access memory.

According to one aspect of the invention, the electronic device is a mobile telephone.

According to one aspect of the invention, the logic circuit is operative to command power to additional memory blocks when the amount of memory defined by the currently powered memory blocks is less than the quantity defined by the adjusted demand page buffer size and the amount of memory utilized for other processing operations.

According to one aspect of the invention, a method for conserving power in a portable electronic device, said portable electronic device including a processing device and a memory, includes: dynamically adjusting a demand page buffer size utilized in the electronic device; and adjusting a number of powered memory blocks based on the adjusting of the demand page buffer size.

According to one aspect of the invention, said dynamically adjusting is based on at least one operating characteristic of the electronic device.

According to one aspect of the invention, dynamically adjusting based on at least one operating characteristic includes using at least one of an amount of free memory available to the processing device, a processing device load, a number of applications executed in parallel by the processing device, or a type of application executed by the processing device.

According to one aspect of the invention, using the processing device load to dynamically adjust the demand page buffer size includes increasing the demand page buffer size as the processing device load increases, and decreasing the demand page buffer size as the processing device load decreases.

According to one aspect of the invention, using the number of applications to dynamically adjust the demand page buffer size includes increasing the demand page buffer size as the number of applications executed in parallel by the processing device increases, and decreasing the demand page buffer size as the number of applications executed in parallel by the processing device decreases.

According to one aspect of the invention, dynamically adjusting the demand page buffer size includes selecting the demand page buffer size from a first buffer size and a second buffer size, wherein the second buffer size is smaller than the first buffer size.

According to one aspect of the invention, selecting the demand page buffer size includes selecting the first buffer size when the amount of free memory available to the processing device is greater than a predetermined memory threshold value, a processing device load is greater than a predetermined load threshold value, a number of applications executed in parallel by the processing device is greater than an application number threshold value, or a type of application executed by the processing device creates a processor load greater than the load threshold value.

According to one aspect of the invention, selecting the demand page buffer size includes selecting the second buffer size when the amount of free memory available to a processing device of the electronic device is less than a predetermined memory threshold value, a processing device load is less than a predetermined load threshold value, a number of applications executed in parallel by the processing device is less than an application number threshold value, or a type of application executed by the processing device creates a processor load less than the load threshold value.

According to one aspect of the invention, dynamically adjusting the demand page buffer size includes calculating the demand page buffer size so as to correspond to the at least one monitored operational characteristic.

According to one aspect of the invention, calculating includes implementing a hysteresis loop in the calculation of the demand page buffer size.

According to one aspect of the invention, adjusting a number of powered memory blocks based on the adjusting of the demand page buffer size includes powering off memory blocks until a difference between an amount of memory defined by the remaining powered memory blocks and the quantity defined by the adjusted demand page buffer size and an amount of memory utilized for other processing operations is less than one memory block.

According to one aspect of the invention, powering on and off memory blocks includes powering on and off memory blocks in static dynamic random access memory.

According to one aspect of the invention, the method further comprises powering on additional memory blocks when the amount of memory defined by the currently powered memory blocks is less than the quantity defined by the adjusted demand page buffer size and the amount of memory utilized for other processing operations.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a schematic view of a mobile telephone as an exemplary electronic device in accordance with an embodiment of the present invention.

FIG. 2 is a schematic block diagram of the relevant portions of the mobile telephone of FIG. 1 in accordance with an embodiment of the present invention.

FIG. 3 is a schematic diagram of a communications system in which the mobile telephone of FIG. 1 may operate.

FIG. 4 is a flow chart of an exemplary dynamic page buffering function in accordance with the present invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smart phones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a portable gaming device, or the like.

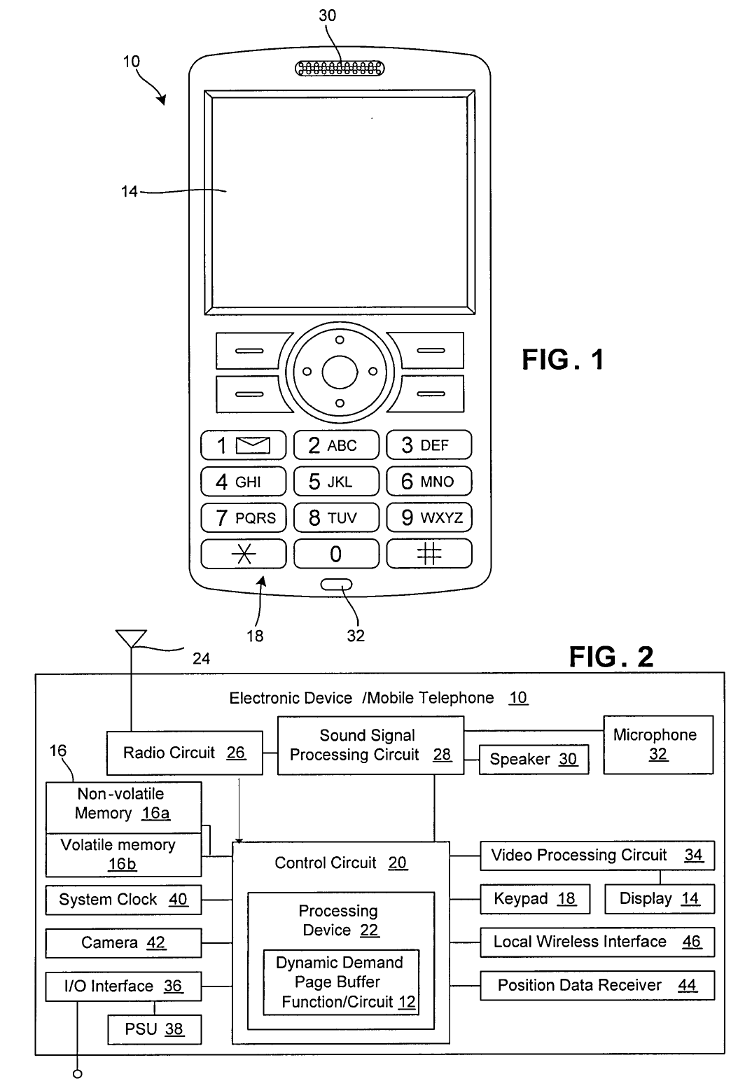

Referring initially to FIGS. 1 and 2, an electronic device 10 is shown. The electronic device 10 includes a dynamic demand page buffer function 12 that is configured to dynamically change a demand page buffer size based on one or more operating characteristics of the electronic device 10. Additional details and operation of the dynamic demand page buffer function 12 will be described in greater detail below. The dynamic demand page buffer function 12 may be embodied as executable code that is resident in and executed by the electronic device 10. In one embodiment, the dynamic demand page buffer function 12 may be a program stored on a computer or machine readable medium. The dynamic demand page buffer function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for simple message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth. FIG. 2 represents a functional block diagram of the mobile telephone 10. For the sake of brevity, generally conventional features of the mobile telephone 10 will not be described in great detail herein.

The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10.

The memory 16 may include a read only memory area that is implemented using nonvolatile memory 16a, and a random access or system memory area that is implemented using volatile memory 16b. As will be appreciated, nonvolatile memory tends not to lose data storage capability upon loss of power and is typically used to store data, application code, files and so forth. The nonvolatile memory 16a may be implemented with a flash memory, for example. The flash memory may have a NAND architecture, but other flash memory architectures, such as a NOR architecture, may be used. As will be appreciated, volatile memory tends to lose data storage capability upon loss of power and is typically used to store data for access by the processing device 22 during the execution of logical routines. The volatile memory 16b may be a random access memory (RAM). The RAM may be a synchronous dynamic random access memory (SDRAM), for example, but other RAM architectures that utilize memory blocks may be used. As used herein, a memory block refers to a grouping of memory that is powered or otherwise activated as a group, independent of other memory or other groups of memory not within the instant group Data may be exchanged between the nonvolatile memory 16a and the volatile memory 16b as is conventional. The sizes of the nonvolatile memory 16a and the volatile memory 16b may be sized as is appropriate for the mobile telephone 10 or other electronic device in which the memory 16 is used.

In addition, the processing device 22 may execute code that implements the dynamic demand page buffer function 12. It will be apparent to a person having ordinary skill in the art of computer programming, and specifically in application programming for mobile telephones or other electronic devices, how to program a mobile telephone 10 to operate and carry out logical functions associated with the dynamic demand page buffer function 12. Accordingly, details as to specific programming code have been left out for the sake of brevity. Also, while the dynamic demand page buffer function 12 is executed by the processing device 22 in accordance with a preferred embodiment of the invention, such functionality could also be carried out via dedicated hardware, firmware, software, or combinations thereof, without departing from the scope of the invention. Any of these implementations may be referred to as a dynamic demand page buffer circuit or simply a logic circuit.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 may include a camera 42 for taking digital pictures and/or movies. Image and/or video files corresponding to the pictures and/or movies may be stored in the memory 16.

The mobile telephone 10 also may include a position data receiver 44, such as a global positioning system (GPS) receiver, Galileo satellite system receiver or the like.

The mobile telephone 10 also may include a local wireless interface 46, such as an infrared transceiver and/or an RF interface (e.g., a Bluetooth interface), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices.

As will be appreciated, the server 52 may be configured as a typical computer system used to carry out server functions and may include a processor configured to execute software containing logical instructions that embody the functions of the server 52 and a memory to store such software.

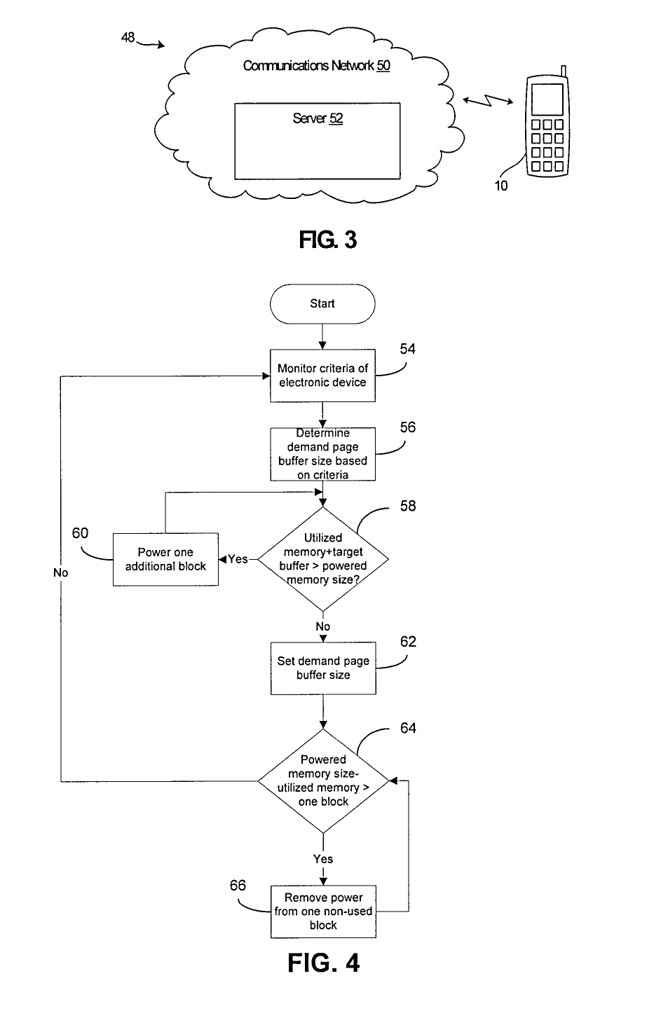

With additional reference to FIG. 4, illustrated are logical operations to implement an exemplary method of dynamically changing the size of the page in demand buffer. The exemplary method may be carried out by executing an embodiment of the dynamic demand page buffer function 12, for example. Thus, the flow chart of FIG. 4 may be thought of as depicting steps of a method carried out by the mobile telephone 10. Although FIG. 4 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the dynamic demand page buffer function 12 may begin in block 54 where one or more operating characteristics of the electronic device are monitored. The one or more operating characteristics may include a processing load placed on the processing device 22, wherein load is defined as a percentage of full utilization of the processing device 22. The one or more operating characteristics also may include an amount of free system memory 16b in the electronic device 10 (e.g., how much system memory 16b is unused within the electronic device 10), or on a number of applications executed by the processing device 22 (e.g., the number of applications being executed simultaneously or in parallel by the processing device 22). The one or more operating characteristics also may include the type of application being executed by the processing device (e.g., processor intensive or non-intensive applications). For example, applications that produce audio and video may be highly processor intensive, while applications related to phone books, text messaging, etc. may not be processor intensive.

Next at block 56, the one or more monitored operating characteristics are evaluated and a target size of the demand page buffer is determined. The determination of the target dynamic demand page buffer size may be a simple selection between a predetermined large buffer and small buffer. For example, a large buffer can be set at a first size, and a small buffer can be set at a second size, wherein the second size is less than the first size. Then, based on the monitored operating characteristic(s), either the first or second buffer is selected as the target demand page buffer size. For example, if the processing load is high (e.g., greater than 50 percent load on the processing device 22, and more preferably greater than 70 percent load on the processing device 22), the amount of free powered system memory 16b is relatively large (e.g., more than a predetermined amount of system memory 16b, such as more than 50 percent, within a powered memory block is free), the number of applications executed in parallel is high (e.g., three or more applications executed in parallel by the processing device 22), and/or the type of application executed by the processing device 22 is processor intensive (e.g., a video application), then the first buffer (i.e., the large buffer) may be used as the target demand page buffer. Conversely, if the processing load is low (e.g., less than 51 percent load, more preferably less than 30 percent load), the amount of free powered system memory is relatively small (e.g., less than 50 percent of a powered memory block is free), the number of applications executed in parallel is small (e.g., less than three applications executed in parallel by the processing device 22), and/or the type of application executed by the processing device 22 is not processor intensive (e.g., a text message application), then the second buffer (i.e., the small buffer) may be used as the target demand page buffer.

Alternatively, the target demand page buffer size may be calculated based on the one or more operating characteristics (e.g., as the monitored operating characteristic(s) varies, the buffer size also varies). For example, if the load on the processing device 22 is at 50 percent, then the target demand page buffer may be set at 50 percent (or some other percentage) of a preset value (e.g. 50 percent of a maximum buffer size). Then, as load increases or decreases, the target page demand buffer size can vary with the load. Preferably, the target demand page buffer remains fixed for certain levels of the operating characteristic(s) (e.g., it includes a level of hysteresis). For example, between 50 and 59 percent load on the processing device 22, the target demand page buffer size can remain at 50 percent of the preset value. Then, for example, as load increases between 60 and 69 percent (or drops between say 10 and 19 percent) the target demand page buffer size can be set to 60 percent (or 10 percent) of the predetermined value throughout the particular range. As will be appreciated, the above sizes of the target demand page buffer with respect to the one or more monitored operating characteristics is merely exemplary, and other relationships may be used to determine the target demand page buffer size without departing from the scope of the invention.

At block 58, it is determined whether or not the active memory (e.g., the system memory currently powered in the electronic device 10) is of sufficient size to accommodate the new demand page buffer. For example, a certain amount of memory may be used for various house keeping tasks, This used or reserved memory size can be added to the target demand page buffer size to determine a minimum memory size for implementing the new demand page buffer. If the minimum memory size is greater than the available memory (e.g., the powered memory), then at block 60 an additional block of memory is powered and the process moves back to block 58 and repeats until the amount of powered memory can accept the target demand page buffer and the reserved memory.

If the minimum memory size is less than or equal to the available memory (e.g., the powered memory), then there is sufficient memory to accept the new demand page buffer, and at block 62, the demand page buffer utilized by the electronic device is set to the target demand page buffer.

At block 64, it is determined whether or not the new demand page buffer enables memory blocks to be turned off (e.g., power removed from one or more blocks). Removing power from memory blocks can reduce current draw from the electronic device's battery. Memory can be turned off, for example, when the amount of powered memory is greater than the utilized memory (i.e., the memory consumed by the demand page buffer and any other memory utilized by the processing device 22) by at least one memory block. For example, if each memory block can store 100 MB of data and 6 memory blocks are currently powered, then the current memory configuration can store 600 MB. If the memory consumed by the demand page buffer in combination with other memory utilized by the processing device 22 is less than 600 MB by at least 1 memory block (100 MB per block in this example), then power can be removed from at least one memory block (e.g. if the demand page buffer and other memory utilized by the processor is 350 MB, and the total powered memory is 600 MB, then the required memory is 400 MB and, thus, power can be removed from two memory blocks). If one or more memory blocks can be turned off, then at block 66, the data within the memory 16b may be reorganized so as to “defragment” the data or otherwise move the data from the memory block that is about to be powered down to a block that will remain powered, and then power is removed from the unused memory block. The process then moves back to block 64 and repeats until all the memory blocks that can be turned off are turned off. Once this occurs, then the method moves back to block 54 and the process repeats.

Accordingly, an electronic device and method for dynamically changing the demand page buffer size has been described. By changing the demand page buffer size based on one or more operating characteristics of the electronic device, blocks of memory can be de-energized during periods of low use, thereby saving battery power. Then, should the conditions call for a larger demand page buffer, the buffer can be increased in size and additional memory brought online to optimize performance.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A portable electronic device, comprising:
a processing device;
a memory operatively coupled to said processing device, said memory comprising a plurality of blocks, wherein at least one block of the plurality of blocks may be powered independent of other blocks of the plurality of blocks; and
a logic circuit operative to dynamically adjust a demand page buffer size within the memory and utilized by the processor, thereby permitting a corresponding adjustment of a number of powered memory blocks within the memory.

2. The electronic device of claim 1, wherein the logic circuit is operative to dynamically adjust the demand page buffer size based on at least one operating characteristic of the electronic device.

3. The electronic device of claim 2, wherein the logic circuit is operative to use at least one of an amount of free memory available to the processing device, a processing device load, a number of applications executed in parallel by the processing device, or a type of application executed by the processing device to adjust the demand page buffer size.

4. The electronic device of claim 3, wherein the logic circuit is operative to increase the demand page buffer size as the processing device load increases, and decrease the demand page buffer size as the processing device load decreases.

5. The electronic device of claim 3, wherein the logic circuit is operative to increase the demand page buffer size as the number of applications executed in parallel by the processing device increases, and decrease the demand page buffer size as the number of applications executed in parallel by the processing device decreases.

6. The electronic device of claim 3, wherein the logic circuit is operative to select the demand page buffer size from a first buffer size and a second buffer size, wherein the second buffer size is smaller than the first buffer size.

7. The electronic device of claim 6, wherein the logic circuit is operative to select the first buffer size when the amount of free memory available to the processing device is greater than a predetermined memory threshold value, a processing device load is greater than a predetermined load threshold value, a number of applications executed in parallel by the processing device is greater than an application number threshold value, or a type of application executed by the processing device creates a processor load greater than the load threshold value.

8. The electronic device of claim 6, wherein the logic circuit is operative to select the second buffer size when the amount of free memory available to the processing device is less than a predetermined memory threshold value, a processing device load is less than a predetermined load threshold value, a number of applications executed in parallel by the processing device is less than an application number threshold value, or a type of application executed by the processing device creates a processor load less than the load threshold value.

9. The electronic device of claim 3, wherein the logic circuit is operative to calculate the demand page buffer size so as to correspond to the at least one monitored operational characteristic.

10. The electronic device of claim 9, wherein the logic circuit is operative to implement a hysteresis loop in the calculation of the demand page buffer size.

11. The electronic device of claim 1, wherein the logic circuit is operative to power off memory blocks until a difference between an amount of memory defined by the remaining powered memory blocks and the quantity defined by the adjusted demand page buffer size and an amount of memory utilized for other processing operations is less than one memory block.

12. The electronic device of claim 11, wherein the memory is static dynamic random access memory.

13. The electronic device of claim 1, wherein the electronic device is a mobile telephone.

14. The electronic device of claim 1, wherein the logic circuit is operative to command power to additional memory blocks when the amount of memory defined by the currently powered memory blocks is less than the quantity defined by the adjusted demand page buffer size and the amount of memory utilized for other processing operations.

15. A method for conserving power in a portable electronic device, said portable electronic device including a processing device and a memory, comprising:
dynamically adjusting a demand page buffer size utilized in the electronic device; and
adjusting a number of powered memory blocks based on the adjusting of the demand page buffer size.

16. The method of claim 15, wherein said dynamically adjusting is based on at least one operating characteristic of the electronic device.

17. The method of claim 16, wherein dynamically adjusting based on at least one operating characteristic includes using at least one of an amount of free memory available to the processing device, a processing device load, a number of applications executed in parallel by the processing device, or a type of application executed by the processing device.

18. The method of claim 17, wherein using the processing device load to dynamically adjust the demand page buffer size includes increasing the demand page buffer size as the processing device load increases, and decreasing the demand page buffer size as the processing device load decreases.

19. The method of claim 17, wherein using the number of applications to dynamically adjust the demand page buffer size includes increasing the demand page buffer size as the number of applications executed in parallel by the processing device increases, and decreasing the demand page buffer size as the number of applications executed in parallel by the processing device decreases.

20. The method of claim 17, wherein dynamically adjusting the demand page buffer size includes selecting the demand page buffer size from a first buffer size and a second buffer size, wherein the second buffer size is smaller than the first buffer size.

21. The method of claim 20, wherein selecting the demand page buffer size includes selecting the first buffer size when the amount of free memory available to the processing device is greater than a predetermined memory threshold value, a processing device load is greater than a predetermined load threshold value, a number of applications executed in parallel by the processing device is greater than an application number threshold value, or a type of application executed by the processing device creates a processor load greater than the load threshold value.

22. The method of claim 20, wherein selecting the demand page buffer size includes selecting the second buffer size when the amount of free memory available to a processing device of the electronic device is less than a predetermined memory threshold value, a processing device load is less than a predetermined load threshold value, a number of applications executed in parallel by the processing device is less than an application number threshold value, or a type of application executed by the processing device creates a processor load less than the load threshold value.

23. The method of claim 16, wherein dynamically adjusting the demand page buffer size includes calculating the demand page buffer size so as to correspond to the at least one monitored operational characteristic.

24. The method of claim 23, wherein calculating includes implementing a hysteresis loop in the calculation of the demand page buffer size.

25. The method of claim 15, wherein adjusting a number of powered memory blocks based on the adjusting of the demand page buffer size includes powering off memory blocks until a difference between an amount of memory defined by the remaining powered memory blocks and the quantity defined by the adjusted demand page buffer size and an amount of memory utilized for other processing operations is less than one memory block.

26. The method of claim 25, wherein powering on and off memory blocks includes powering on and off memory blocks in static dynamic random access memory.

27. The method of claim 25, further comprising powering on additional memory blocks when the amount of memory defined by the currently powered memory blocks is less than the quantity defined by the adjusted demand page buffer size and the amount of memory utilized for other processing operations.
